(19) United States
(12) Patent Application Publication
(10) Pub. No.: US 2019/0368950 A1
(43) Pub. Date: Dec. 5, 2019

(54) SENSOR DEVICE

(71) Applicant: Sumitomo Riko Company Limited, Aichi (JP)

(72) Inventors: Junya KAWAGUCHI, Aichi (JP); Tomohiro FUJIKAWA, Aichi (JP); Susumu SATO, Aichi (JP); Shota YAMAMOTO, Aichi (JP)

(73) Assignee: Sumitomo Riko Company Limited, Aichi (JP)

(21) Appl. No.: 16/542,309

(22) Filed: Aug. 16, 2019

Related U.S. Application Data
(63) Continuation of application No. PCT/JP2018/001171, filed on Jan. 17, 2018.

(30) Foreign Application Priority Data
Mar. 21, 2017 (JP) 2017-055029

(51) Int. Cl. G01L 1/14; B25J 19/06; B25J 13/08

(52) U.S. Cl. CPC G01L 1/14; B25J 13/086; B25J 19/063

(57) ABSTRACT

Provided is a sensor device having a structure, with which the use of a simple structure enables accurate detection of a worker, etc. approaching or contacting a moving part of an automatic device. This sensor device detects the approach or contact of a detection target with a mobile moving part that is provided in an automatic device. The moving part is provided with a first sensor and second sensor for detecting the approach or contact of the detection target. The first sensor and second sensor have the same detection principle and the detection circuit of the first sensor and the detection circuit of the second sensor have the same structure.

### CROSS-REFERENCE TO RELATED APPLICATION

The present application is a continuation of PCT/JP2018/001171, filed on Jan. 17, 2018, and is related to and claims priority from Japanese patent application no. 2017-055029, filed on Mar. 21, 2017. The entire contents of the aforementioned application are hereby incorporated by reference herein.

### TECHNICAL FIELD

The present disclosure relates to a sensor device which detects approach or contact between a moving part of an automatic device such as an industrial robot and a detection target.

### BACKGROUND ART

Conventionally, automatic devices such as industrial robots and industrial vehicles are generally used in factories and the like, for example, due to the implementation of industrial automation. Such an automatic device is a moving part, of which the whole or a part is movable to perform a predetermined operation, such as an arm of an industrial robot.

Incidentally, as adoption of automatic devices has increased, it has also become necessary to improve the safety of the automatic devices such as cooperative robots which work with human workers in the same space. That is, in the case in which an industrial robot and a worker are working in the same space, it is very important to prevent the occurrence of accidents caused by an arm colliding with the worker or a tool used by the worker or the like when the arm or the like of the industrial robot moves and to avoid injury to the worker and damage to the arms, tools and the like when these come into contact with each other.

Therefore, U.S. Pat. No. 7,031,807 (Patent Document 1) proposes a method of stopping a device capable of avoiding a collision of a movable part by controlling movement of the movable part movable in a space based on detection results of a tactile sensor and a capacitive sensor. In the configuration for realizing the method of stopping a device, a tactile sensor and a capacitive sensor are provided on the movable part, approach of a human body or an object to the movable part is detected by the capacitive sensor, contact of a human body or an object with the movable portion is detected by the tactile sensor, and a collision between a movable part and a human body or object is prevented by stopping the device on the basis of a response of the sensors.

However, in Patent Document 1, since it is necessary to provide detection circuits corresponding to the sensors including the tactile sensor using an optical waveguide and the capacitive sensor using change in capacitance and thus to provide detection circuits of multiple types, this takes time and labor, and the configuration of a sensor device including the detection circuit is complicated.

In view of the above description, a sensor device is provided to have a structure which is capable of accurately detecting approach or contact of a worker or the like with respect to a moving part of an automatic device with a simple structure.

In addition, elements adopted in each of the aspects described below can be adopted in any combination as far as possible.

### SUMMARY

According to one embodiment of the disclosure a sensor device is provided to detect approach or contact of a detection target with a moving part that is movably provided in an automatic device. The sensor device comprises a first sensor and a second sensor which are provided in the moving part, detect the approach or the contact of the detection target with the moving part, and have the same detection principles; and a detection circuit of the first sensor and a detection circuit of the second sensor, which have the same structure.

### BRIEF DESCRIPTION OF DRAWINGS

FIG. 1 is a side view showing a robot with a sensor device according to the first embodiment of the present disclosure.

FIG. 2 is a cross-sectional view schematically showing a part of an arm of the robot shown in FIG. 1.

FIG. 3 is a perspective view schematically showing a first sensor shown in FIG. 2 in a disassembled state.

FIG. 4 is a block diagram of hardware including the first and the second sensors and detection circuits thereof shown in FIG. 2.

FIG. 5 is a block diagram of main functions implemented by the hardware shown in FIG. 4.

FIG. 6 is a block diagram of alternative hardware including the first and the second sensors and the detection circuits thereof shown in FIG. 2.

FIG. 7 is a cross-sectional view schematically showing a part of an arm according to another embodiment of the present disclosure.

FIG. 8 is a cross-sectional view schematically showing a part of an arm according to still another embodiment of the present disclosure.

FIG. 9 is a cross-sectional view schematically showing a part of an arm constituting a robot with a sensor device according to the second embodiment of the present disclosure.

FIG. 10 is a cross-sectional view schematically showing a part of an arm according to yet another embodiment of the present disclosure.

FIG. 11 is a side view showing a robot with a sensor device according to the third embodiment of the present disclosure.

FIG. 12 is a cross-sectional view schematically showing a part of an arm of the robot shown in FIG. 11.

### DESCRIPTION OF EMBODIMENTS

Hereinafter, embodiments of the present disclosure will be described with reference to the drawings.

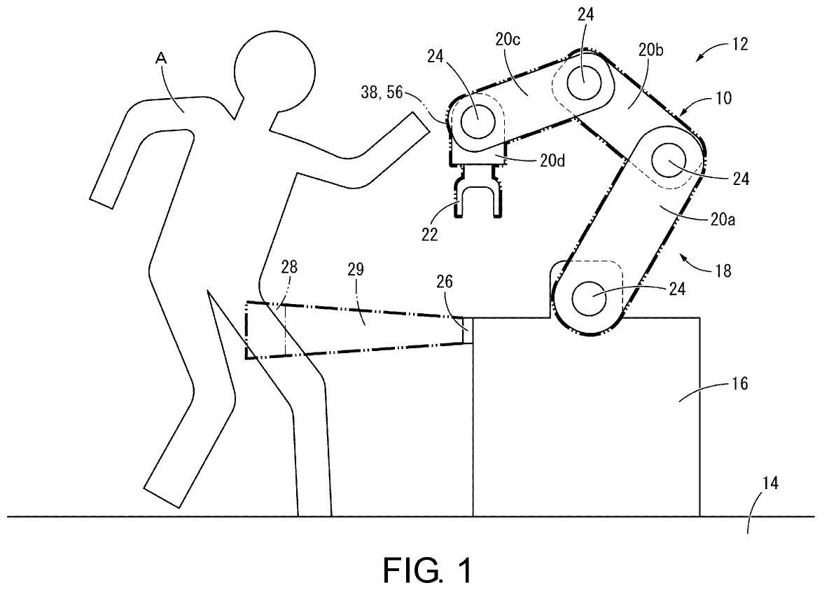

FIG. 1 shows a robot 12 as an automatic device with a sensor device 10 according to the first embodiment of the present disclosure. The robot 12 has a structure in which an arm 18 as a moving part is movably mounted on a support base 16 fixed to a floor 14, and the sensor device 10 provided in the robot 12 detects approach or contact between the arm 18 and a worker A as a detection target.

More specifically, the arms 18 includes links 20a, 20b, 20c, and 20d which are connected to each other by joint parts to be capable of relative tilting, the link 20a is tiltably connected to the support base 16, and a gripping part 22 as an end effector is provided on the link 20d.

In the embodiment, although the joint parts which connect the links 20a to 20d to each other and a connection part between the link 20a and the support base 16 are all tiltable around a rotary shaft 24 extending in a direction perpendicular to the sheet of FIG. 1, the robot 12 may be capable of, for example, tilting around a rotary axis extending in a vertical direction or a horizontal direction in FIG. 1 or twisting around a link center axis. Further, although the gripping part 22 is exemplified as the end effector of the arm 18, various known end effectors such as a suction hand and the like may be adopted according to an operation performed by the robot 12.

Further, an approach detection sensor 26 is provided in the support base 16. The approach detection sensor 26 is a sensor capable of detecting the worker A located at a position relatively far from the support base 16 and is, for example, a laser sensor or an ultrasonic sensor and can detect the worker A approaching the support base 16 from the front at a position away from the support base 16 and the arm 18 by emitting laser light or ultrasonic waves from the support base 16 forward. An approach detection region 28 in which the approach detection sensor 26 can detect the worker A extends forward from the support base 16 as shown by a two-dot dashed line in FIG. 1 and reaches a position farther from the robot 12 as compared with a first detection region 38 and a second detection region 56 described later. Further, the approach detection region 28 extends in a band or fan shape with a predetermined width in the direction perpendicular to the sheet of FIG. 1.

In the embodiment, the approach detection sensor 26 is provided on the support base 16 which does not move, and the approach detection region 28 of the approach detection sensor 26 includes a danger zone 29 that is a range, within which the arm 18 can move, and extends to a range surrounding the danger zone 29. Therefore, the approach detection sensor 26 can detect the worker A outside the danger zone 29 indicated by a dashed dotted line in FIG. 1 and can detect the worker A before the worker A enters the danger zone 29. However, the approach detection region 28 can also be set to change, for example, as the arm 18 moves.

The danger zone 29 of the embodiment is set to extend in the horizontal direction at a predetermined height and is set in front of the support base 16 as shown by a dashed dotted line in FIG. 1. The danger zone 29 does not necessarily have to be an entire zone in which the arm 18 can move and a collision between the worker A and the arm 18 can occur and may be a part of a zone in which a collision between the worker A and the arm 18 can occur. Specifically, the danger zone 29 may be set, for example, only in front of the arm 18 to which the worker A can approach or may be set in only a part in a height direction and may not be set above the arm 18 in which the approach of the worker A is not a problem. Additionally, since the approach detection region 28 of the approach detection sensor 26 is set to extend to the outside of the danger zone 29, the approach detection sensor 26 detects the worker A before contact between the worker A and the arm 18.

The approach detection sensor 26 is not limited to a laser sensor or an ultrasonic sensor provided on the support base 16, and various known sensors capable of realizing the intended approach detection region 28 can be adopted. Specifically, the approach detection sensor 26 for detecting the approach of the worker A to the support base 16 or the like may be configured by, for example, providing a light curtain, a photoelectric sensor, or the like on the support base 16 or therearound and laying a mat-shaped surface pressure sensor on a surface of the floor 14 located on the side in front of the support base 16.

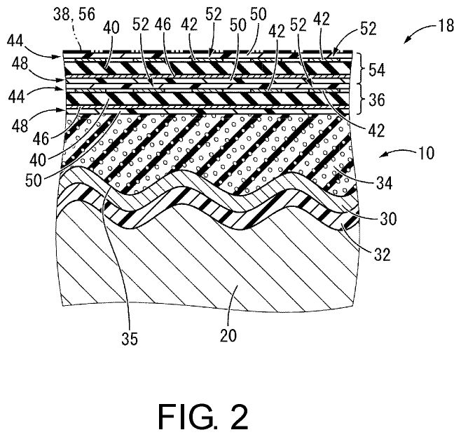

Further, as shown in FIG. 2, shield layers 30 are respectively provided outside the links 20. The shield layer 30 is provided to block electromagnetic waves or the like emitted to the outside from the arm 18 disposed inside the shield layer 30 and is formed of, for example, a conductive metal such as iron, copper, or an aluminum alloy. The shield layer 30 according to the embodiment is formed by a silk screen printing method or the like on a surface of a support body 32 which is a flexible and insulating resin film formed of polyethylene terephthalate (PET) or the like using, for example, a paint obtained by dispersing metal powder in a base material such as rubber or a synthetic resin. Additionally, the shield layer 30 is disposed to cover an outer surface of the link 20 by attaching the support body 32 to the surface of the link 20. The shield layer 30 may be formed of a thin metal plate or mesh and may also be obtained by forming a coating film by directly spraying a paint in which metal powder is dispersed in a base material on the surface of the link 20 or the like. Also, the thickness of the support body 32 is not particularly limited as long as it can be flexibly deformed.

Further, an elastic cushion layer 34 is provided on the outside of the shield layer 30. The elastic cushion layer 34 is formed of rubber, resin elastomer, or the like and may be formed of open cell or closed cell foam, or a mixture of open and closed cells. The material for forming the elastic cushion layer 34 is not particularly limited, but for example, semi-rigid urethane foam, etc. can be adopted. However, the elastic cushion layer 34 may be formed of non-foamed rubber or resin elastomer.

In the elastic cushion layer 34 of the embodiment, an inner surface 35 on the link 20 side has a shape corresponding to an outer surface of the link 20 having roughness, and an outer surface opposite to the link 20 is formed to be flat. In the embodiment, since the shield layer 30 and the support body 32 are disposed between the elastic cushion layer 34 and the link 20 but both the shield layer 30 and the support body 32 are flexible and sufficiently thin and are disposed along the outer surface of the link 20, the elastic cushion layer 34 is substantially directly superimposed on the outer surface of the link 20. Also, in FIG. 2, although the roughness of the outer surface of the link 20 is schematically illustrated, the roughness of the outer surface of the link 20 can be formed, for example, due to an arrangement of a control circuit or wiring of the arm 18, a design of a link housing, a screwing structure, and the like.

Furthermore, a first sensor 36 is superimposed on the outside of the elastic cushion layer 34. The first sensor 36 is a contact sensor which detects contact of the worker A with the arm 18, and in the embodiment, a capacitive-type planar pressure sensor is employed. However, various known contact sensors can be adopted for the first sensor 36 and, for example, an impact sensor using piezoelectric ceramic, a touch sensor such as of a resistive film type, an infrared type or a surface acoustic wave type, a flow sensor which detects a flow of air due to deformation of the elastic layer at the time of contact, a membrane switch, and the like may be adopted. Furthermore, a sensor built into the robot 12 may be used as the first sensor 36, and for example, a force sensor, a torque sensor, an encoder sensor, or the like may be employed as the first sensor 36. As shown by a two-dot dashed line in FIGS. 1 and 2, the first detection region 38 in which the worker A can be detected by the first sensor 36 is set closer to the arm 18 than the approach detection region 28 of the approach detection sensor 26.

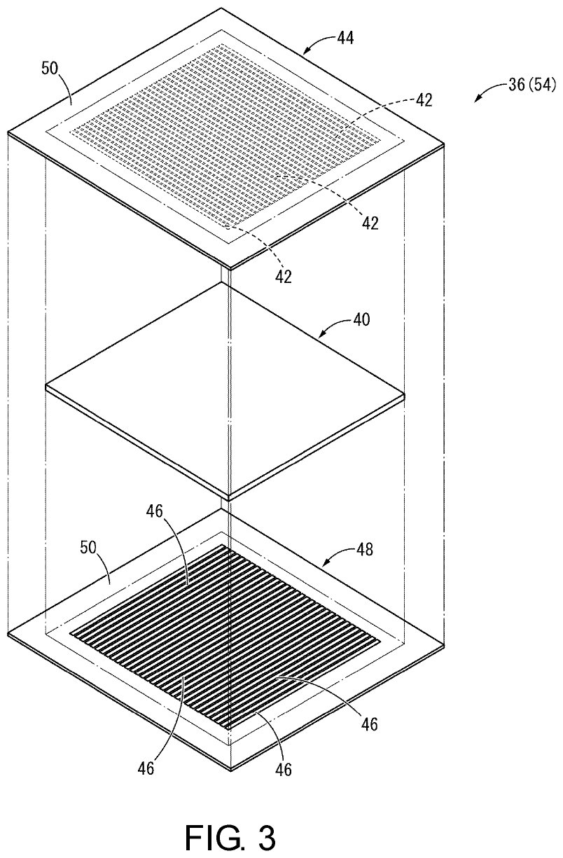

As shown in FIG. 3, the first sensor 36 of the embodiment has a structure in which a first electrode sheet 44 including a plurality of first electrodes 42 parallel to each other and a second electrode sheet 48 including a plurality of second electrodes 46 parallel to each other are respectively superimposed on and fixed to both surfaces of a dielectric layer 40.

The dielectric layer 40 is an elastically deformable sheet-shaped electrical insulator formed of rubber or resin elastomer and may be formed of non-foamed rubber which hardly causes a volume change. The dielectric layer 40 may be integrally formed with the first electrode sheet 44 and the second electrode sheet 48 which will be described later.

The first electrode sheet 44 has a structure in which the plurality of strip-shaped first electrodes 42 having conductivity are formed in parallel on an electrically insulating sheet-shaped base body 50. Each of the first electrodes 42 is formed by mixing an elastic material such as a rubber with a conductive material such as a carbon filler or metal powder and is formed to be stretchable and deformable. The first electrode 42 can be formed on the base body 50 by screen printing or the like.

Like the first electrode sheet 44, the second electrode sheet 48 has a structure in which a plurality of strip-shaped conductive second electrodes 46 which are stretchable and deformable are formed in parallel on the electrically insulating and sheet-shaped base body 50. The forming material of the second electrode 46 and the method of forming the second electrode 46 on the base body 50 are the same as those of the first electrode 42.

Additionally, the first sensor 36 is formed by the first electrode sheet 44 and the second electrode sheet 48 being superimposed on the dielectric layer 40 from each side in the thickness direction and fixed thereto by means such as adhesion or welding. In the superimposed state of the dielectric layer 40, the first and the second electrode sheets 44 and 48, a longitudinal direction of the first electrodes 42 and a longitudinal direction of the second electrodes 46 are different from each other, and the first electrodes 42 and the second electrodes 46 cross and face each other with the dielectric layer 40 interposed therebetween. Thus, a pressure detection part 52 which detects the pressure acting in a facing direction based on change in capacitance is formed in each crossing and facing portion of the first electrodes 42 and the second electrodes 46 (refer to FIG. 2). Therefore, the first sensor 36, which has a structure that a plurality of pressure detection parts 52 are disposed in a dispersed manner, is formed as a surface pressure sensor of capacitive-type that detects the pressure acting on the surface based on the change in capacitance. Although the rectangular sheet-shaped first sensor 36 is shown in FIG. 3, the specific shape of the first sensor 36 is appropriately set according to the shapes of the links 20a to 20d or the like. In addition, the first electrodes 42 and the second electrodes 46 are not limited to a strip shape and may be formed in, for example, a plurality of independent spot shapes and may be disposed to face each other.

Further, a second sensor 54 is superimposed on the outside of the first sensor 36. Since the second sensor 54 is configured by a contact sensor as in the first sensor 36 and has substantially the same structure as that of the first sensor 36, a detailed description is omitted and the same reference numerals are provided in the drawings. As apparent from the same structure, the first sensor 36 and the second sensor 54 are sensors which detect the worker A by the same detection principle, and in the embodiment, the worker A is detected based on the change in capacitance.

Furthermore, the second detection region 56 in which the worker A can be detected by the second sensor 54 is set to a position closer to the arm 18 than the approach detection region 28 of the approach detection sensor 26. Since the second detection region 56 of the second sensor 54 is the same as the first detection region 38 of the first sensor 36 and is set to a position which overlaps the first detection region 38, and the first sensor 36 and the second sensor 54 are contact sensors in the embodiment, the first detection region 38 and the second detection region 56 are set on a surface of the second sensor 54, as shown by a two-dot dashed line in FIGS. 1 and 2.

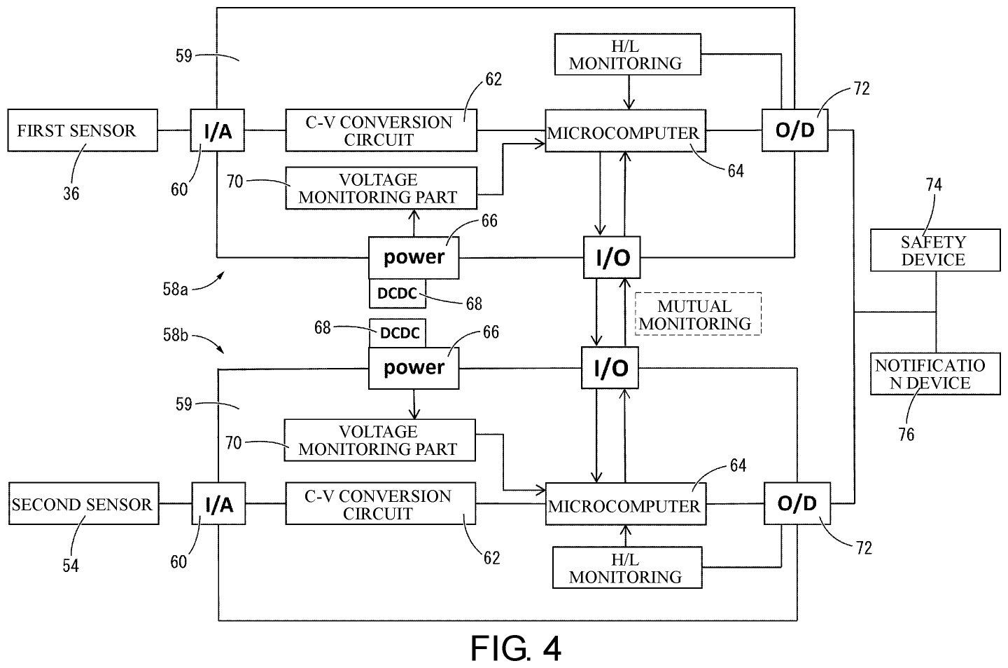

Further, as shown in FIG. 4 which is a block diagram of main hardware, detection circuits 58a and 58b are respectively connected to the first sensor 36 and the second sensor 54. Here, since the first sensor 36 and the second sensor 54 are both capacitive type sensors, and the worker A is detected based on the same detection principle, i.e., the change in capacitance, the detection circuit 58a connected to the first sensor 36 and the detection circuit 58b connected to the second sensor 54 have the same structure. In the following, the detection circuit 58a will be described, and the specific configuration of the detection circuit 58b will be omitted and the same reference numeral is provided to the detection circuit 58a in the drawing.

The detection circuit 58a has a structure in which various integrated circuits, connectors and the like are mounted on a printed circuit board 59 and is connected to the first and second electrodes 42 and 46 of the first sensor 36 at an analog input part 60 mounted on the printed circuit board 59. Further, the detection circuit 58a includes a C-V conversion circuit 62 which converts a detection signal of the capacitance of the first sensor 36 into a corresponding voltage and includes a microcomputer 64 connected to the C-V conversion circuit 62. The microcomputer 64 has a function of controlling detection of pressure made by the first sensor 36, such as a function in which a detection current is supplied to the plurality of pressure detection parts 52 of the first sensor 36 in a scanning manner and a pressure acting on each of the pressure detection parts 52 is detected. Furthermore, the microcomputer 64 has a function of filtering the voltage signal converted from the detection signal of the capacitance of the first sensor 36 to reduce noise and then converting the filtered voltage signal into a digital signal. In addition, an external power supply device (not shown) is connected to a power input part 66 provided in the detection circuit 58a, and a direct current of the power supply device is supplied to the microcomputer 64 through a voltage monitoring part 70 in a state that a voltage is adjusted by a DC-DC converter 68.

The microcomputer 64 of the detection circuit 58a connected to the first sensor 36 and the microcomputer 64 of the detection circuit 58b connected to the second sensor 54 may monitor whether or not the first sensor 36 and the second sensor 54 are operating normally by comparing a detection result of the first sensor 36 with a detection result of the second sensor 54, or the like.

Additionally, digital signals generated by the microcomputers 64 of the detection circuits 58a and 58b are output from digital output parts 72 and 72 of the detection circuits 58a and 58b to the outside. The digital signals output from the detection circuits 58a and 58b are transmitted to, for example, a safety device 74 and a notification device 76. The safety device 74 can decelerate or stop the arm 18, or the notification device 76 such as a monitor or a speaker can display, for example, a warning for approach to the arm 18, an operation procedure required to restart the stopped arm 18, or the like based on the digital signals generated from the detection signals of the first and second sensors 36 and 54.

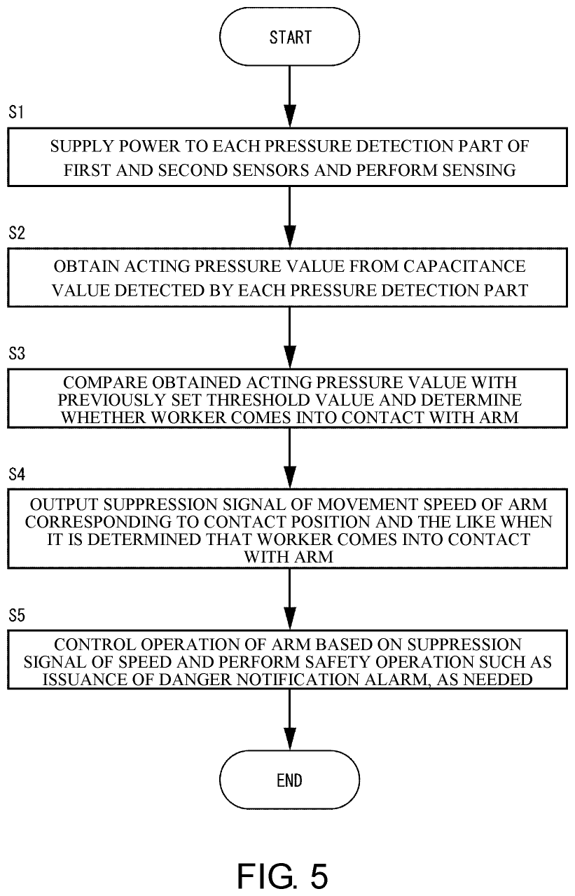

That is, a block diagram of main functions implemented by hardware including the microcomputer 64 is shown in FIG. 5. First, in Step (hereinafter, referred to as S) 1, the power is supplied to each of the pressure detection parts 52 of the first and the second sensors 36 and 54 in a scanning manner, and the capacitance of each of the pressure detection parts 52 is measured. Next, in S2, a value of the pressure acting on each of the pressure detection parts 52 is acquired based on the capacitance value of each of the pressure detection parts 52 of the first and the second sensors 36 and 54. Next, in S3, the acquired action pressure value is compared with a threshold value input and set in advance, and the presence or absence of contact of the worker A with the arm 18 is determined. When it is determined in S3 that there has been contact with a human body, in S4, an inhibition signal of a moving speed of the arm 18 corresponding to a contact location is output in consideration of the contact location, a magnitude of the detected pressure, and the like. The safety device 74 controls the operation of the arm 18 (for example, decelerates or stops the arm 18), and the notification device 76 performs issuance of a danger notification alarm, and the like as needed based on the inhibition signal of the speed.

Further, specific circuit structures of electrical elements of the hardware for realizing the hardware block configuration shown in FIG. 4 and the functional block configuration shown in FIG. 5 have the same design. In addition to the analog input part 60, the C-V conversion circuit 62, the voltage monitoring part 70, the digital output unit 72, and the input/output (I/O) part in FIG. 4, the microcomputer 64 may be of the same package in various forms such as DIP, SIP, PGA, SOJ or the like. An external storage element may be used as the microcomputer 64, and a packaged product including a logic circuit for realizing a desired function such as a CPU, a RAM, and a ROM may also be used. Additionally, for example, setting values of thresholds set in the microcomputer 64 can simply be used differently as needed.

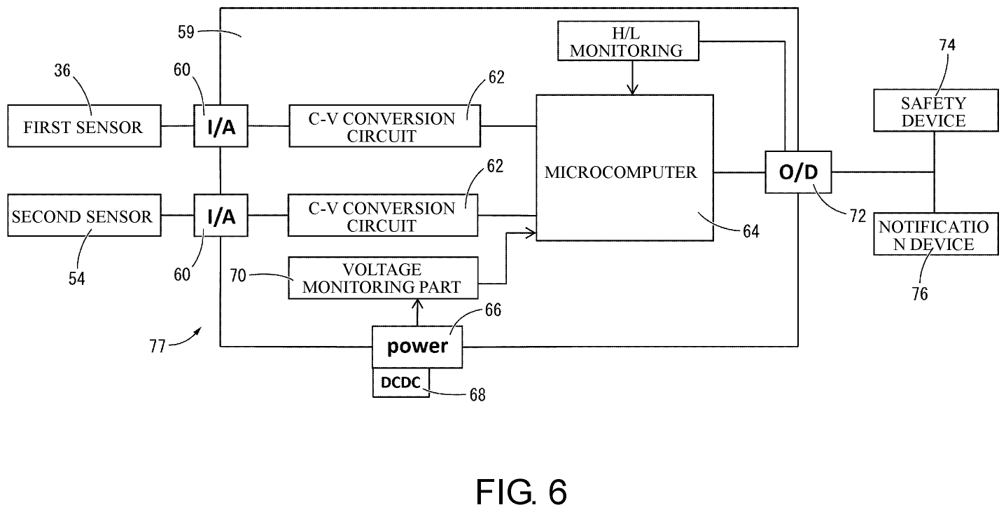

Further, as shown in FIG. 6, the first sensor 36 and the second sensor 54 may be connected to one detection circuit 77 so that the single detection circuit 77 can be shared. That is, in the detection circuit 77, for example, the microcomputer 64 includes an input/output channel for the first sensor 36 and an input/output channel for the second sensor 54, and the controls of the detection operations of the first sensor 36 and the second sensor 54, the processing of the detection signals, and the like can be performed in parallel. Additionally, since the first sensor 36 and the second sensor 54 are sensors having the same detection principle for detecting contact based on the change in capacitance, one detection circuit 77 can be shared by the first sensor 36 and the second sensor 54.

The sensor device 10 of the embodiment includes the first and the second sensors 36 and 54, the detection circuits 58a and 58b of the first and second sensors 36 and 54, the shield layer 30, the support body 32, and the elastic cushion layer 34, and is mounted on the support base 16 and the arm 18 of the robot 12. However, like the approach detection sensor 26, in addition to the sensor device 10, another sensor may be provided to improve detection accuracy of the worker A or to achieve multi-stage detection.

As shown in FIG. 1, when the worker A as the detection target approaches the robot 12 provided with the sensor device 10 having such a structure, the worker A is first detected by the approach detection sensor 26 at a position relatively far from the arm 18. When the approach detection sensor 26 detects the worker A, the detection signal of the approach detection sensor 26 is converted into a digital signal by the detection circuit (not shown) and transmitted to the safety device 74, the notification device 76, and the like. Thus, the moving speed of the arm 18 is reduced by the safety device 74, and the worker A is warned to leave the arm 18 by the notification device 76. The safety device 74 or the notification device 76 may be accommodated in the support base 16 or the link 20. Furthermore, the detection circuit of the approach detection sensor 26 or the detection circuits 58a and 58b of the first and second sensors 36 and 54 may be accommodated in the support base 16 or the link 20.

Although the moving speed of the arm 18 after the deceleration is appropriately set according to a distance between the arm 18 and the worker A which is detected by the approach detection sensor 26, or the like, a force acting on the worker A can be sufficiently reduced, for example, by decelerating to 250 mm/sec or less and stopping the arm 18 when contact of the worker A with the arm 18 is detected by the first and second sensors 36 and 54.

Next, when the worker A further approaches the arm 18, and thus the worker A comes into contact with the arm 18, the worker A is detected by both the first sensor 36 and the second sensor 54 at a position closer to the arm 18 than a distal end (a front end) of the approach detection region 28 of the approach detection sensor 26. Additionally, the contact of the worker A with the arm 18 is detected by the first sensor 36 and the second sensor 54, the detection signals of the first and second sensors 36 and 54 converted into digital signals by the detection circuits 58a and 58b are transmitted to, for example, the safety device 74 or the notification device 76, and thus the safety device 74 stops the operation of the arm 18. Also, the notification device 76 warns the worker A to leave the arm 18, and the notification device 76 displays a procedure necessary for restarting the arm 18.

Thus, according to the robot 12 provided with the sensor device 10 in the embodiment, three sensors including the approach detection sensor 26 which detects the worker A at a long distance, and the first sensor 36 and the second sensor 54 which detect the worker A at a short distance are provided. Therefore, the approach and the contact of the worker A with the arm 18 can be detected with higher reliability based on the detection results of the three sensors 26, 36, and 54.

Here, both the first sensor 36 and the second sensor 54 which detect the worker A at a short distance are capacitive type sensors which detect the contact of the worker A with the arm 18 based on the change in capacitance. As described above, since the first sensor 36 and the second sensor 54 are configured by sensors having the same detection principle, it is possible to use the same detection circuits 58a and 58b, and commonization of the structure of the detection circuits 58a and 58b facilitates manufacture or management of the detection circuits 58a and 58b.

Also, as shown in FIG. 6, since both the first sensor 36 and the second sensor 54 are connected to the single detection circuit 77, the first sensor 36 and the second sensor 54 can share the detection circuit 77, and simplification of the structure and space saving for arranging the detection circuit 77 can be achieved.

Further, since the approach of the worker A is detected by the approach detection sensor 26 and the arm 18 is decelerated before the worker A comes into contact with the arm 18, the arm 18 can be stopped promptly when the contact of the worker A with the arm 18 is detected. Therefore, the force acting on the worker A by the contact of the arm 18 becomes small sufficiently, and it is possible to avoid a problem such as the worker A feeling pain or damage to the arm 18 due to the contact.

Further, the worker A is detected by both the first sensor 36 and the second sensor 54 at a position closer to the arm 18 than the approach detection sensor 26. Thus, the arm 18 can be stopped with greater reliability when the worker A comes into contact with the arm 18, and thus as the force acting between the worker A and the arm 18 is reduced, safety can be improved.

Further, since each of the first sensor 36 and the second sensor 54 is configured by the flexible capacitive type sensor having the deformable dielectric layer 40 and the electrodes 42 and 46, the excellent detection accuracy is realized, the force acting on the worker A when the worker A and the arm 18 are in contact with each other is further relaxed, and the safety is further improved.

In the embodiment, since both the first sensor 36 and the second sensor 54 are contact sensors, and the first detection region 38 of the first sensor 36 and the second detection region 56 of the second sensor 54 overlap each other, the contact of the worker A with the arm 18 is detected by both the first sensor 36 and the second sensor 54. Therefore, since the stopping of the arm 18 based on the detection of the contact between the arm 18 and the worker A is performed with better reliability, the force acting when the arm 18 and the worker A comes into contact with each other is more reliably reduced, and the safety can be additionally improved.

Further, in the embodiment, since both the first sensor 36 and the second sensor 54 are disposed outside the elastic cushion layer 34, the detection accuracy of the contact of the worker A with the arm 18 made by the first sensor 36 and the second sensor 54 can be prevented from being lowered by a buffer property of the elastic cushion layer 34. Therefore, when the arm 18 comes into contact with the worker A, the contact of the worker A with the arm 18 can be effectively detected by the first and second sensors 36 and 54 while the force acting on the worker A is reduced by the buffer property of the elastic cushion layer 34.

Further, in the embodiment, the approach detection region 28 of the approach detection sensor 26 is fixedly set to include the surrounding of the danger zone 29 in which the arm 18 may move. Thus, before the worker A enters the danger zone 29, the worker A is detected by the approach detection sensor 26 at a position sufficiently away from the arm 18, and the arm 18 can be sufficiently decelerated before the contact of the worker A with the arm 18.

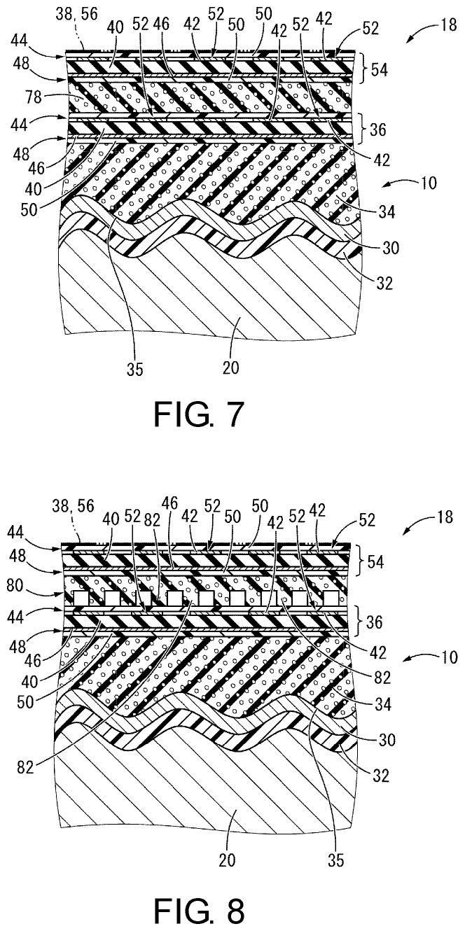

As shown in FIG. 7, an intermediate cushion layer 78 may be provided between the first sensor 36 and the second sensor 54. The intermediate cushion layer 78 is formed of, for example, an elastic material which is the same as that of the elastic cushion layer 34 provided between the first sensor 36 and the shield layer 30 and is formed in a substantially flat shape. According to the structure having such an intermediate cushion layer 78, since it is possible to further improve the buffer property when the worker A comes into contact with the arm 18, and detection sensitivity of the first sensor 36 and the second sensor 54 which are configured by the contact sensors can be adjusted by the intermediate cushion layer 78. For example, it is easy to set the detection sensitivity of the first sensor 36 lower than the detection sensitivity of the second sensor 54.

Further, as shown in FIG. 8, an intermediate cushion layer 80 in which an overlapping surface to the first sensor 36 is formed into a rough surface shape can also be provided between the first sensor 36 and the second sensor 54. The intermediate cushion layer 80 is provided outside the first sensor 36 and includes a plurality of convex parts 82 which protrude toward the first sensor 36, and the plurality of convex parts 82 are provided at portions corresponding to the plurality of pressure detection parts 52 of the first sensor 36 and are in contact with the pressure detection parts 52 of the first sensor 36. Accordingly, when the worker A comes into contact with the arm 18, the pressure due to the contact is caused to intensively act by the convex parts 82 on each of the pressure detection parts 52 which are detection parts of the first sensor 36 while the force acting on the worker A is effectively reduced, and the contact of the worker A with the arm 18 can be detected with excellent sensitivity. An aspect of the convex part 82 corresponding to the pressure detection part 52 should just transmit the contact pressure to the pressure detection part 52 efficiently and may be, for example, an aspect such as providing the pressure detecting parts 52 only at substantially the same positions as the convex portions 82 and providing the convex parts 82 at least some of which are located on the pressure detection parts 52 as illustrated.

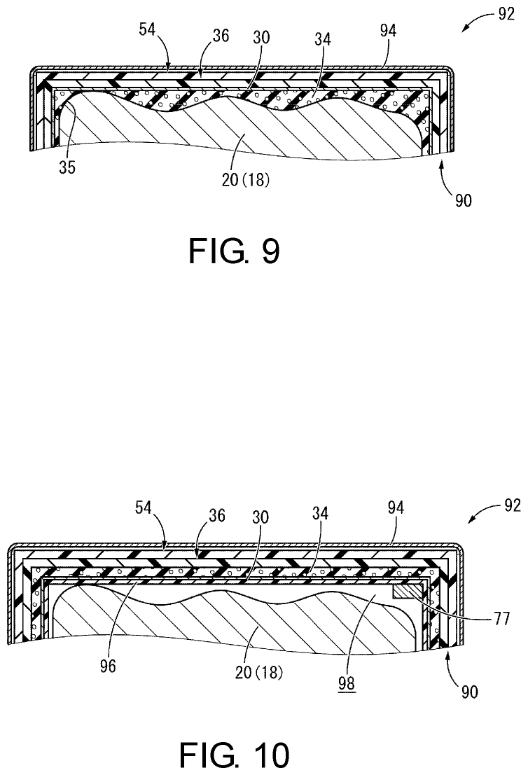

Further, FIG. 9 shows a part of a robot 92 as an automatic device with a sensor device 90 according to the second embodiment of the present disclosure. The robot 92 of the embodiment has a structure in which the sensor device 90 is mounted at the outside of the link 20 which constitutes the arm 18. In the following description, parts which are substantially the same as those of the first embodiment are designated by the same reference numerals in the drawings, and the description thereof will be omitted. The entire robot 92 is the same as the robot 12 of the first embodiment, and an approach detection sensor (not shown) which is the same as that of the first embodiment is provided on a support base (not shown) which supports the arm 18. Also, in FIG. 9 and FIG. 10 described later, although the electrodes and the dielectric layers of the first sensor 36 and the second sensor 54 are omitted for easy viewing, the specific structures of the first sensor 36 and the second sensor 54 are the same as those of the first embodiment.

More specifically, an elastic cushion layer 34 is fixed to the outer surface of the link 20. In the elastic cushion layer 34, an inner surface 35 thereof located on the link 20 side has a surface shape corresponding to roughness of a surface of the link 20, and an outer surface thereof opposite to the link 20 is formed of a plurality of flat surfaces.

A shield layer 30 and a first sensor 36 are disposed on the outside of the elastic cushion layer 34. The shield layer 30 of the embodiment is printed on a surface of a second electrode sheet 48 of the first sensor 36, and the shield layer 30 is disposed between the first sensor 36 and the elastic cushion layer 34.

Furthermore, a second sensor 54 is disposed on the outside of the first sensor 36, and the outside of the second sensor 54 is covered by a cover 94. The cover 94 is formed of a flexible material such as leather, cloth, or an elastomer sheet including a vinyl sheet or a rubber sheet and prevents adhesion of dirt to the second sensor 54, and the like.

Also in the robot 92 with the sensor device 90 having the structure according to the embodiment, as in the first embodiment, the arm 18 can be prevented from colliding with a detection target such as a worker using the approach detection sensor (not shown) which detects a detection target at a distant position away from the arm 18, and the first sensor 36 and the second sensor 54 which detect the contact of the detection target with the arm 18.

Also, as shown in the embodiment, the shield layer 30 may be disposed at the inside closer to the link 20 than the first sensor 36 and the second sensor 54 and may also be disposed outside the elastic cushion layer 34. Further, in the embodiment, since the shield layer 30 is fixed to the second electrode sheet 48 of the first sensor 36, a support body for supporting the shield layer 30 is not required, and thus the structure can be simplified and the number of parts can be reduced.

Although FIG. 9 shows an example in which an outer surface of the elastic cushion layer 34 is formed in a substantially rectangular box shape including a plurality of flat surfaces, this is a simplification for ease of understanding, and as a shape of the outer surface of the elastic cushion layer 34, any surface shape which facilitates provision of the first and second sensors 36 and 54 and the shield layer 30 compared to the surface of the link 20 may be employed. Further, for example, the shape of the outer surface of the elastic cushion layer 34 can be set to form at least a part of a specific design. Furthermore, the surface shape of the link 20 covered by the elastic cushion layer 34 is not particularly limited.

Also, as shown in FIG. 10, a structure in which a support cover 96 is provided to cover the link 20, and the shield layer 30, the elastic cushion layer 34, the first and second sensors 36 and 54, and the cover 94 are provided on the surface of the support cover 96 can also be adopted. The support cover 96 of the embodiment is in the form of a hollow box and is disposed to surround the outside of the link 20 by accommodating the link 20 in an accommodation space 98 therein. As described above, since the surface of link 20 is covered by support cover 96, the shield layer 30, the elastic cushion layer 34, the first and second sensors 36 and 54, and the cover 94 are easily provided on the outside of the link 20 regardless of the roughness of the surface of the link 20.

Further, in FIG. 10, the detection circuit 77 or the like of the first and second sensors 36 and 54 can be accommodated between the support cover 96 and the link 20 in the accommodation space 98. Although FIG. 10 illustrates the structure in which the detection circuit 77 is disposed in the accommodation space 98 in a state of being fixed to the support cover 96, for example, the detection circuit 77 or the like disposed in the accommodation space 98 may be fixed to the link 20.

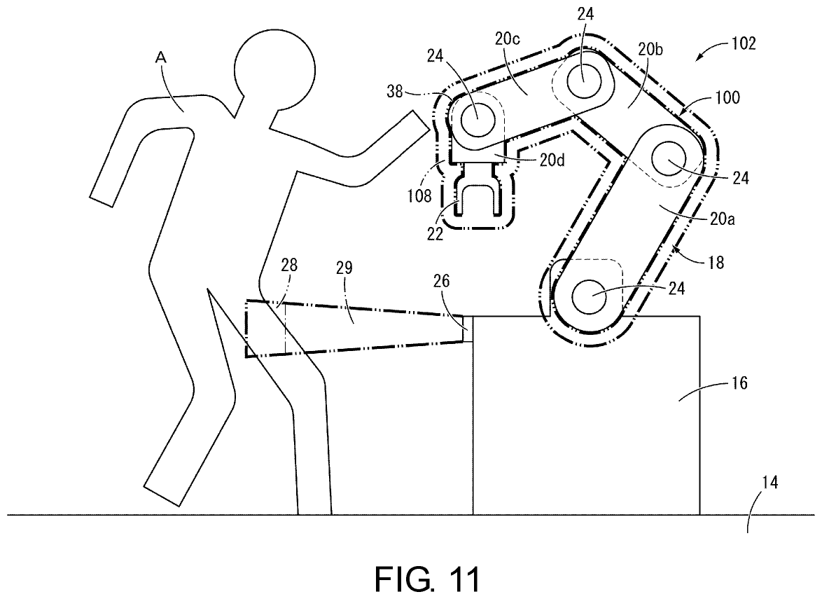

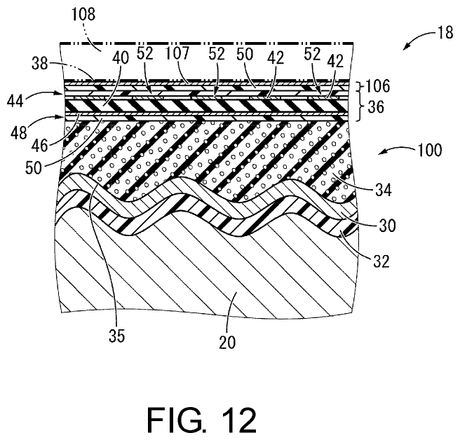

Further, FIG. 11 shows a robot 102 as an automatic device with a sensor device 100 according to the third embodiment of the present disclosure. In the embodiment, a second sensor 106 (refer to FIG. 12) provided on the arm 18 of the robot 102 is a proximity sensor which can detect the worker A without contact at a position away from the arm 18.

As the second sensor 106, various known proximity sensors may be employed, and, for example, a capacitive sensor which detects approach of a conductor or a dielectric to an electrode, an optical sensor such as a light curtain or a laser sensor, an ultrasonic sensor, or the like may be employed. As shown in FIG. 12, the second sensor 106 of the embodiment is a capacitive sensor having a structure in which an electrode 107 is formed by printing on an upper surface of the base body 50 and is also configured to detect the approach of a conductor (here, the worker A) such as a human body to the electrode 107 as change in capacitance of a capacitor formed of the electrode 107 and the conductor. Further, as shown by the two-dot dashed line in FIGS. 11 and 12, a second detection region 108 in which the worker A is detected using the second sensor 106 is set to a position closer to the robot 12 than the approach detection area 28 of the approach detection sensor 26 and extends to a position farther from the robot 12 than the first detection region 38 of the first sensor 36.

The second sensor 106 of the embodiment is a sensor in which the worker A is detected both in a noncontact manner and in a contact manner. Specifically, for example, when an approach detection type capacitive sensor which detects change in capacitance due to the approach of a conductor such as a human body in a noncontact manner is employed as the second sensor 106, the worker A can be detected by the second sensor 106 in both a non-contact state and a contact state of the worker A with the arm 18. Thus, the second detection region 108 of the second sensor 106 extends to a position farther from the arm 18 than the first detection region 38 of the first sensor 36 and includes a surface of the first sensor 36 which is the same as the first detection region 38. Therefore, the second detection region 108 partially overlaps the first detection region 38 and is set to a region different from the first detection region 38 in a direction away from the arm 18.

In the robot 102 with the sensor device 100 having the structure according to the embodiment, the approach of the worker A to the arm 18 is detected stepwise by the approach detection sensor 26 and the second sensor 106, and the contact of the worker A with the arm 18 is detected by both the first sensor 36 and the second sensor 106.

That is, when the worker A approaches the arm 18 side further than the distal end of the approach detection region 28 of the approach detection sensor 26 and intrudes into the second detection region 108 of the second sensor 106, the worker A is detected by the second sensor 106 in a noncontact manner before the worker A and the arm 18 come into contact with each other. Additionally, when the approach of the worker A to the arm 18 is detected by the second sensor 106, a detection signal of the second sensor 106 converted into a digital signal by the detection circuit 58b is transmitted to a safety device (not shown) which controls the movement of the arm 18 or a notification device which performs display or sound generation on the basis of the detection result, and thus the safety device further decelerates the movement of the arm 18, and the notification device warns the worker A to leave the arm 18.

Thus, in the embodiment, for example, the moving speed of the arm 18 can be reduced stepwise due to the detection of the worker A by the approach detection sensor 26 and the second sensor 106 before the worker A comes into contact with the arm 18, and thus the force acting on the worker A upon contact with the arm 18 can be made smaller. The movement of the arm 18 may be stopped by the detection of the worker A by the second sensor 106. In this case, the first sensor 36 can also serve as a fail-safe when the second sensor 106 cannot correctly detect the detection target, for example, due to a failure or the like.

Further, in the embodiment, since the second sensor 106 can detect not only the approach of the worker A to the arm 18 but also the contact, the contact of the worker A with the arm 18 is detected by both the first sensor 36 and the second sensor 106, but the second sensor 106 may be able to detect the approach of the worker A to the arm 18 only in the non-contact state.

In the embodiment, since both the first sensor 36 and the second sensor 106 are capacitive sensors, a detection circuit of a common structure may also be employed, like the detection circuits 58a and 58b of the first embodiment. Furthermore, for example, in the detection circuits 58a and 58b of the first sensor 36 and the second sensor 106, the detection sensitivity of the first sensor 36 and the second sensor 106 can also be adjusted by making coefficients at the time of signal conversion by the C-V conversion circuit 62 different from each other or amplifying the detection signal of the second sensor 106.

Although the embodiments of the present disclosure have been described above in detail, the present disclosure is not limited by the specific description. For example, the first sensor and the second sensor may employ, in combination, a proximity sensor in which the detection target is detected at a position away from the arm without contact and a contact sensor in which contact of the detection target with the arm is detected, and both the first sensor and the second sensor may be proximity sensors or may be contact sensors.

Furthermore, the first detection region of the first sensor and the second detection region of the second sensor do not necessarily have to be set to partially or entirely overlap each other and may also be set to different ranges without the overlapping portion. Also, in such a case, the detection target can be detected by both the first sensor and the second sensor, and the deceleration and the stop of the arm can be performed on the arm side further than the distal end of the approach detection region of the approach detection sensor.

Also, the first sensor and the second sensor are not limited to the capacitive sensors, and various well-known proximity sensors or contact sensors such as an electrical resistance type sensor, a laser sensor, and an ultrasonic sensor can be employed. Furthermore, sensors incorporated in an automatic device such as a sensor which detects a current of a motor for driving a joint part of an arm or a sensor which detects a torque acting on a joint part of an arm may also be used as the first sensor and the second sensor. The first sensor and the second sensor are desirably flexible sensors but may be rigid sensors as long as safety at the time of contact is ensured.

The approach detection sensor is provided on the support base which is out of the moving part such as the arm as in the embodiment described above and detects an intrusion of a detection target into a fixedly set area, and may also be provided in the moving part to detect an intrusion of a detection target into an area set to change as the moving part moves.

Further, the approach detection sensor may be any sensor as long as the approach detection region extends farther than the first detection region of the first sensor and the second detection region of the second sensor and may adopt, for example, a structure in which both the first sensor and the second sensor are contact sensors and the approach detection sensor is a proximity sensor such as a capacitive sensor which detects the approach of the detection target at a position close to the arm. The approach detection sensor is not essential in the present disclosure.

In the above-described embodiment, the worker A is exemplified as the detection target detected by the approach detection sensor and the first and second sensors, but the detection target is not limited to a person and may be an object. Further, it is desirable that cushioning materials such as an elastic cushion layer and an intermediate cushion layer be disposed to reduce the force acting at the time of contact of the detection target, but the elastic cushion layer and the intermediate cushion layer are not essential.

Further, an automatic device in which the sensor device according to the present disclosure is mounted is not limited to the industrial robot shown in the above-described embodiment and may be applied to, for example, a medical or nursing robot or an automated guided vehicle (AGV). In the above-described embodiment, the structure in which a part of the automatic device is the moving part is exemplified. However, for example, when the automatic device is the AGV, the entire automatic device is the moving part.

Other Configurations

According to one embodiment of the disclosure a sensor device is provided to detect approach or contact of a detection target with a moving part that is movably provided in an automatic device. The sensor device comprises a first sensor and a second sensor which are provided in the moving part, detect the approach or the contact of the detection target with the moving part, and have the same detection principles; and a detection circuit of the first sensor and a detection circuit of the second sensor, which have the same structure.

According to the sensor device having the structure of the first aspect, the detection principles of the first sensor and the second sensor are the same as each other, and the detection circuit of the first sensor and the detection circuit of the second sensor have the same structure. Therefore, simplification of manufacture of the detection circuit of the first sensor and the detection circuit of the second sensor, sharing of one detection circuit in the first sensor and the second sensor, and the like are realized.

In the second aspect of the present disclosure, according to the sensor device described in the first aspect, the first sensor and the second sensor may share one detection circuit.

According to the second aspect, simplification of the structure, space saving of a mounting space, and the like can be achieved by realizing the detection of the detection target by a plurality of sensors with one detection circuit.

In the third aspect of the present disclosure, according to the sensor device described in the first or second aspect, a detection region of the first sensor and a detection region of the second sensor may overlap each other.

According to the third aspect, since the detection target can be doubly detected by the first sensor and the second sensor at a position in which the detection region of the first sensor and the detection region of the second sensor overlap each other, detection accuracy can be improved, and reliability of the detection can be improved.

In the fourth aspect of the present disclosure, according to the sensor device described in any one of the first to third aspects, the detection region of the first sensor and the detection region of the second sensor may have different ranges in a direction away from the moving part.

According to the fourth aspect, the approach of the detection target to the moving part can be detected stepwise by the first sensor and the second sensor. For example, when the detection region of the first sensor is set to reach a position farther from the moving part than the detection region of the second sensor, the first sensor detects the approach of the detection target to the moving part at a relatively distant position, and further approach or contact of the detection target to the moving part can be detected by the second sensor. Thus, after the moving part is further decelerated due to the detection of the detection target by the first sensor, stepwise control of the moving part, such as stopping of the moving part with respect to the detection of the detection target by the second sensor, on the basis of the detection results of the first sensor and the second sensor is also possible. Also, for example, at normal times, the stopping of the moving part may be controlled based on the detection result of the first sensor, and the second sensor may be a preliminary sensor which functions at the time of a failure of the first sensor, or the like.

In the fifth aspect of the present disclosure, according to the sensor device described in any one of the first to fourth aspects, the first sensor and the second sensor may be contact sensors which detect the contact between the moving part and the detection target.

According to the fifth aspect, the reliability of detection can be improved by using contact sensors as the first sensor and the second sensor, and for example, when the moving part is stopped due to detecting contact between the detection target and the moving part, unnecessary stopping of the moving part can be prevented.

In the sixth aspect of the present disclosure, according to the sensor device described in the fifth aspect, the first sensor and the second sensor may have a structure in which each of a first electrode and a second electrode which are deformable is fixed to a surface of a dielectric layer that is elastically deformable and may be capacitive sensors which detect a pressure acting on a facing portion of the first electrode and the second electrode via the dielectric layer in a facing direction based on a change in a capacitance value.

According to the sixth aspect, since the contact sensor is a flexible capacitive sensor having a dielectric layer and an electrode which are deformable, excellent detection accuracy is realized, and the force acting on the detection target at the time of the contact with the detection target is easily relaxed, and safety is further improved.

In the seventh aspect of the present disclosure, according to the sensor device described in any one of the first to sixth aspects, an elastic cushion layer for buffer may be disposed outside the moving part, and the first sensor and the second sensor may be disposed outside the elastic cushion layer with respect to the moving part.

According to the seventh aspect, a buffer property of the elastic cushion layer reduces the acting force when the detection target comes into contact with the moving part. Further, even if at least one of the first sensor and the second sensor is a contact sensor, the influence of the elastic cushion layer on the detection accuracy can be minimized by disposing the first sensor and the second sensor outside the elastic cushion layer.

In the eighth aspect of the present disclosure, according to the sensor device described in any one of the first to seventh aspects, an intermediate cushion layer may be disposed between the first sensor and the second sensor.

According to the eighth aspect, the buffer property of the intermediate cushion layer reduces the acting force when the detection target comes into contact with the moving part. Further, when the intermediate cushion layer is disposed between the first sensor and the second sensor, detection sensitivities of the first sensor and the second sensor can be adjusted using the intermediate cushion layer.

In the ninth aspect of the present disclosure, according to the sensor device described in the eighth aspect, the first sensor may be a contact sensor which detects the contact of the detection target with the moving part, the intermediate cushion layer may be disposed outside the first sensor, and an overlapping surface of the intermediate cushion layer on the first sensor may be formed in a roughness shape having convex parts which protrude toward the first sensor.

According to the ninth aspect, since the convex parts of the intermediate cushion layer are superimposed on a detection portion of the first sensor, for example, reduction of the force acting on the detection portion of the first sensor at the time of contact with the detection target is minimized by the buffer property of the intermediate cushion layer, and the detection of contact by the first sensor can be realized with high sensitivity.

According to the present disclosure, the detection principles of the first sensor and the second sensor are set to be the same as each other, and the detection circuit of the first sensor and the detection circuit of the second sensor have the same structure. Therefore, it is possible to realize simplification of manufacture of the detection circuit of the first sensor and the detection circuit of the second sensor and sharing of one detection circuit in the first sensor and the second sensor.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A sensor device which detects approach or contact of a detection target with a moving part that is movably provided in an automatic device, comprising:
a first sensor and a second sensor, which are provided in the moving part, detect the approach or the contact of the detection target with the moving part, and have the same detection principles; and
a detection circuit of the first sensor and a detection circuit of the second sensor, which have the same structure.

2. The sensor device according to claim 1, wherein the first sensor and the second sensor share one detection circuit.

3. The sensor device according to claim 1, wherein a detection region of the first sensor and a detection region of the second sensor overlap each other.

4. The sensor device according to claim 2, wherein a detection region of the first sensor and a detection region of the second sensor overlap each other.

5. The sensor device according to claim 1, wherein the detection region of the first sensor and the detection region of the second sensor have different ranges in a direction away from the moving part.

6. The sensor device according to claim 2, wherein the detection region of the first sensor and the detection region of the second sensor have different ranges in a direction away from the moving part.

7. The sensor device according to claim 1, wherein the first sensor and the second sensor are contact sensors which detect the contact between the moving part and the detection target.

8. The sensor device according to claim 2, wherein the first sensor and the second sensor are contact sensors which detect the contact between the moving part and the detection target.

9. The sensor device according to claim 3, wherein the first sensor and the second sensor are contact sensors which detect the contact between the moving part and the detection target.

10. The sensor device according to claim 5, wherein the first sensor and the second sensor are contact sensors which detect the contact between the moving part and the detection target.

11. The sensor device according to claim 7, wherein the first sensor and the second sensor have a structure in which each of a first electrode and a second electrode which are deformable is fixed to a surface of a dielectric layer that is elastically deformable, and
the first sensor and the second sensor are capacitive sensors which detect a pressure acting on a facing portion of the first electrode and the second electrode via the dielectric layer in a facing direction based on a change in a capacitance value.

12. The sensor device according to claim 8, wherein the first sensor and the second sensor have a structure in which each of a first electrode and a second electrode which are deformable is fixed to a surface of a dielectric layer that is elastically deformable, and
the first sensor and the second sensor are capacitive sensors which detect a pressure acting on a facing portion of the first electrode and the second electrode via the dielectric layer in a facing direction based on a change in a capacitance value.

13. The sensor device according to claim 9, wherein the first sensor and the second sensor have a structure in which each of a first electrode and a second electrode which are deformable is fixed to a surface of a dielectric layer that is elastically deformable, and
the first sensor and the second sensor are capacitive sensors which detect a pressure acting on a facing portion of the first electrode and the second electrode via the dielectric layer in a facing direction based on a change in a capacitance value.

14. The sensor device according to claim 1, further comprising an elastic cushion layer for buffer that is disposed outside the moving part,
wherein the first sensor and the second sensor are disposed outside the elastic cushion layer with respect to the moving part.

15. The sensor device according to claim 2, further comprising an elastic cushion layer for buffer that is disposed outside the moving part,
wherein the first sensor and the second sensor are disposed outside the elastic cushion layer with respect to the moving part.

16. The sensor device according to claim 3, further comprising an elastic cushion layer for buffer that is disposed outside the moving part,
wherein the first sensor and the second sensor are disposed outside the elastic cushion layer with respect to the moving part.

17. The sensor device according to claim 1, further comprising an intermediate cushion layer that is disposed between the first sensor and the second sensor.

18. The sensor device according to claim 2, further comprising an intermediate cushion layer that is disposed between the first sensor and the second sensor.

19. The sensor device according to claim 17, wherein the first sensor is a contact sensor which detects the contact of the detection target with the moving part, the intermediate cushion layer is disposed outside the first sensor, and an overlapping surface of the intermediate cushion layer on the first sensor is formed in a roughness shape having convex parts which protrude toward the first sensor.

20. The sensor device according to claim 18, wherein the first sensor is a contact sensor which detects the contact of the detection target with the moving part, the intermediate cushion layer is disposed outside the first sensor, and an overlapping surface of the intermediate cushion layer on the first sensor is formed in a roughness shape having convex parts which protrude toward the first sensor.
